(19) United States
(12) Patent Application Publication
(10) Pub. No.: US 2020/0129865 A1
(43) Pub. Date: Apr. 30, 2020

(54) Simulation Game Using Actual Organization Data

(71) Applicant: Recurrence, Inc., Seattle, WA (US)

(72) Inventors: Brayden W. Olson, Bellevue, WA (US); Bruce J. Avolio, Shoreline, WA (US); Rob A. Savette, Seattle, WA (US)

(21) Appl. No.: 16/664,682

(22) Filed: Oct. 25, 2019

Related U.S. Application Data
(60) Provisional application No. 62/752,239, filed on Oct. 29, 2018.

(51) Int. Cl. A63F 13/80; A63F 13/65; A63F 13/57; G06F 16/955

(52) U.S. Cl. CPC A63F 13/80; G06F 16/955; A63F 13/57; A63F 13/65

(57) ABSTRACT

A technology is described for a simulation game. In one example of the technology, organization data can be obtained from an actual organization, and success metrics and derivative metrics that impact the success metrics may be identified. Organization roles may be assigned to players and a simulated scenario that is based on the organization data may be provided to the players. The players may be instructed to make decisions regarding the simulated scenario based on the roles assigned to the players, and the decision may be used to calculate values for the derivative metrics. The values of the derivative metrics may be aggregated to generate a value of a success metric for the organization. In the process, player behaviors, actions, and inactions may be used to build demonstrated performance-based behavioral profiles for each player within an organizational context.

### RELATED APPLICATION

This application claims priority to U.S. Provisional Application No. 62/752,239, filed Oct. 29, 2018, which is incorporated herein by reference.

### BACKGROUND

A simulation game may generally be designed to closely simulate real world activities. A simulation game attempts to copy various activities from actual life in the form of a game for various purposes such as training, analysis, or prediction. A simulation game may be a replica of reality. As a training program, a simulation game may allow players to learn through interactive experiences. Simulations may contain elements of experiential learning and adult learning. As such, simulations may be useful for learning about complex situations, where the problems may be unfamiliar, and where the cost of errors in making decisions is likely to be high. As such, simulation games may offer many benefits, such as accelerating and compressing time to offer foresight for simulated scenarios, promoting creativity among players who may develop a shared view of the player's learning and behaviors, as well as other benefits.

### BRIEF DESCRIPTION OF THE DRAWINGS

FIG. 1 is a diagram illustrating a high level example of a method for constructing a simulation game to simulate an actual organization using organization data in accordance with an example of the present technology.

FIGS. 2A-F illustrate example simulation game interfaces in accordance with an example of the present technology.

FIG. 3 is a flow diagram that illustrates an example of a simulation game and a simulated scenario in accordance with an example of the present technology.

FIGS. 4A-B illustrate one example of a simulation game constructed using example airline organization data in accordance with an example of the present technology.

FIG. 5 illustrates an example of an analytics dashboard in accordance with an example of the present technology.

FIG. 6 is a block diagram that illustrates various example components included in a system for hosting a simulation game platform in accordance with an example of the present technology.

FIG. 7 is a flow diagram that illustrates an example method for a simulation game for assessing player behavior in context of an actual organization in accordance with an example of the present technology.

FIG. 8 is block diagram illustrating an example of a computing device that may be used to execute a simulation game in accordance with an example of the present technology.

### DETAILED DESCRIPTION

A technology is described for a simulation game used to evaluate player behavior in the context of an actual organization. The technology uses organization data collected from an actual organization, such as a business, non-profit organization, educational institution, or any other type of organization, and the organization data collected from the actual organization can be used to construct a simulation game that represents in part the actual organization. As one example, organization data collected from an actual organization can be evaluated to identify one or more categories of success metrics for the organization that represent various areas of success of the organization. The organization data may then be evaluated to identify derivative metrics that collectively drive the success metrics (e.g., derivative metrics feed into a success metric, such that the derivative metrics can be aggregated to determine the success metric). Thereafter, the organization data may be used to construct a simulated scenario from the context of the actual organization. A simulated scenario may simulate an aspect of organizational management that involves organizational decision making. The simulated scenario can be provided to one or more players who can be assigned organization roles that exist within the actual organization and are associated with the derivative metrics.

In one example, players can be instructed to make decisions that impact the derivative metrics associated with the organization roles assigned to the players, and the decisions selected by the players can be used to calculate the derivative metrics. The values of the derivative metrics can be aggregated to generate success metrics for the simulated scenario, and the success metrics can be evaluated to determine whether the decisions selected by the players contributed to the success of the simulated scenario.

In another example, players can be instructed to make decisions which may be within that organization's context and behavioral people analytics data can be generated for the players by evaluating the decisions. In some examples, the decisions may not impact a success metric. As an illustration, a player may be asked for an opinion about an issue that is not related to a success metric, and the opinion provided by the player can be analyzed to generate behavioral people analytics data. In one example, demonstrated decisions made by a player during a simulated scenario can be evaluated and a behavioral profile can be generated based on: the behaviors of the player, demonstrated decisions made by the player, and/or inaction of the player (e.g., a failure to select a decision). A behavioral profile for a player can indicate at least one demonstrated behavioral attribute of the player. Simulation game output, such as quantitative data, qualitative data, and behavioral profiles generated as part of executing simulated scenarios can be exported to other human capital management (HCM) systems to allow the simulation game output to be used in association with an organization's employee decision making or people analytics in general. Moreover, practitioners may be provided with simulation game output and the practitioners can use the behavioral people analytics output by the simulation game to inform work including, but not limited to, assessment, learning, leadership selection, leadership development, organizational design, decision rights, recruiting and hiring.

The simulation game may be single player or multiplayer, and a player's decisions may factor into impacting the derivative metrics during game play. The simulation game may be configured to model historical decisions made by the organization, as well as to model alternative outcomes that the organization could have made, thereby allowing for multiple permutations (e.g., hundreds of thousands) of the game simulation. The simulation game may be configured based on current decisions made by the organization, and the organization's current organizational data, to project future possible decisions and outcomes that the organization could make, thereby allowing for multiple forward looking permutations (e.g., hundreds of thousands) of the game simulation. Decisions presented to players may take numerous forms, such as, multiple choice questions, budget allocations along a sliding scale, team choice voting, and more. Each player can make independent decisions and those decisions aggregate together to impact a simulated scenario. Moreover, a number of players may simultaneously be provided with simulated scenarios that are contextual to an actual organization. The simulated scenarios can be used to measure demonstrated behaviors and traits of a player deemed to be valuable by the actual organization.

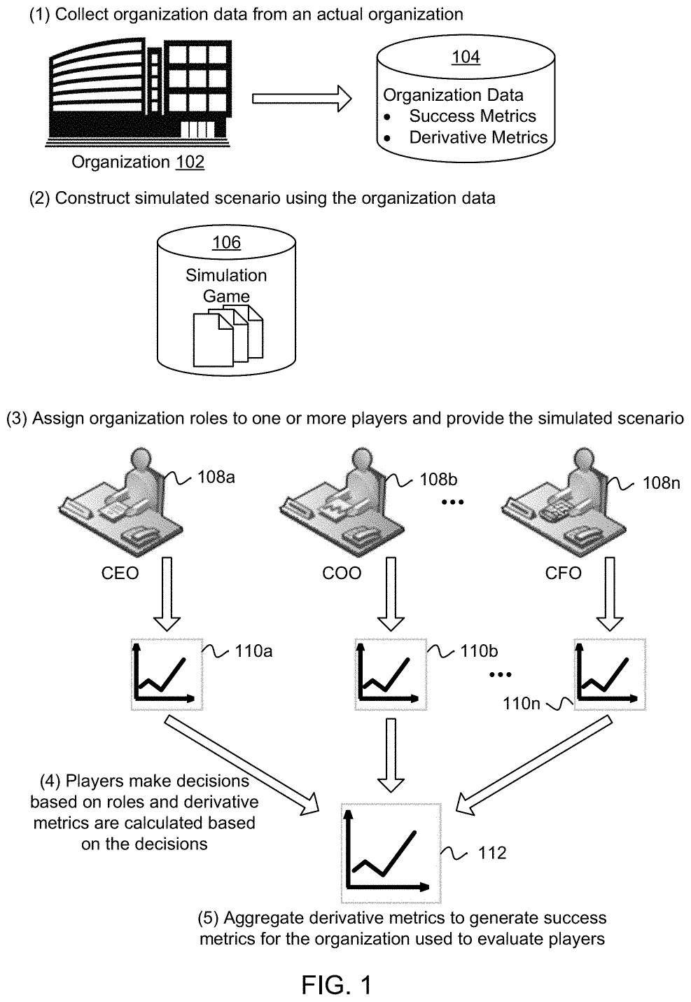

To further describe the present technology, examples are now provided with reference to the figures. FIG. 1 is a diagram illustrating a high level example of a method used to construct a simulation game to simulate various scenarios of an actual organization 102 using organization data. As used herein, an “actual organization” may refer to an existing entity that is organized for some stated purpose, including businesses, non-profit organizations, educational institutions, governments, and the like. In one example, the simulation game can be used to evaluate player behavior in context of an organization 102. In the example illustrated, organization data 104 may be collected from an actual organization 102. The organization data 104 can include any information associated with the organization 102, including organization policies and procedures, financial data, operations data, department data, organization structure information, and other organization information. The organization data 104 may be collected via interviews with organization personnel, observing day-to-day business processes, collecting data from organization databases, organization literature, promotional documents, corporate videos, press conferences, employee events, employee performance data, data archives, data intelligence systems, as well as from any other data source containing organization data 104. The organization data 104 can provide a digital work sample of the organization 102 which can be used to drive simulated scenarios presented to players.

Organization data 104 for an organization 102 may be analyzed to identify success metrics for the organization 102. Many organizations use success metrics to evaluate organization performance. Success metrics may be a quantifiable measure used to track and assess the status of a specific organizational process. For example, an organization's success metrics may track performance associated with sales revenue, profit margin, sales growth, cost of customer acquisition, customer satisfaction, employee satisfaction, and the like. Areas of an organization 102 may have specific performance metrics that may be monitored and these performance metrics may be thought of as derivative metrics which directly impact the success metrics of the organization 102. For example, executives may track employee turnover, sales teams may monitor customer churn rate and return on investment in certain partnerships, and marketers may track marketing and social media metrics, wherein each of these derivative metrics may impact one or more success metrics of the larger organization. The success metrics of an organization 102 may represent the organization's primary objectives, and the success metrics may be used to measure how well the organization 102 may be doing at achieving the organization's primary objectives. As an illustration, success metrics for an organization 102 may include, but are not limited to: sales revenue, net profit margin, gross margin, market growth, shareholder satisfaction, customer satisfaction, and employee satisfaction. Success metrics may be different between organizations based on the organization's primary objectives, and as such, the derivative metrics (e.g. the performance that drives organizational success) may vary based on the organization. The simulation game can be constructed to simulate various scenarios of an organization 102 using the success metrics and derivative metrics that are particular to the organization 102.

A success metric may include a number of derivative metrics that drive the success metric. The derivative metrics may directly and/or indirectly impact an organization's success metrics, and the derivative metrics may collectively determine whether the organization 102 achieves the organization's success metrics. As a non-limiting example, a customer satisfaction metric may be determined, at least in part, by derivative metrics that include: operating revenue, operating margin, operating costs, equity growth, employee productivity, and employee morale. Collectively, these derivative metrics may determine how well the organization is doing in the area of customer satisfaction.

Accordingly, the success metrics of the organization 102 may be analyzed to determine derivative metrics or derivative variables that drive the organization's success metrics. Having collected the organization data 104 and identified the success metrics of the organization 102, along with the derivative metrics that impact the success metrics, a simulation game 106 may be constructed using the organization data 104. In one example, constructing the simulation game 106 may include mapping organization roles 108a-n to derivative metrics. Examples of organization roles 108a-n include corporate roles (e.g., chief executive officer (CEO), chief operating officer (COO), chief financial officer (CFO), department manager, supervisors, etc.), company roles (e.g., owner, office manager, department lead, board of director, etc.), government roles (mayor, city manager, department manager, etc.). The organization roles 108a-n may be associated with organization activity, functions, or decisions that generate the derivative metrics. For example, a CEO may make workforce decisions that impact employee morale, which may be a derivative metric of employee satisfaction and customer satisfaction. A CFO may make financial decisions that impact organization finances, which may be a derivative metric of financial stability, reputation, and employee turnover. Thus, mapping organization roles to derivative metrics, which drive organizational performance within a simulation game 106 allows players to make contextual decisions that may directly impact the derivative metrics. The player's decisions can be aggregated to calculate organization performance, which can be used to evaluate the player's ability to make independent decisions that further the organization's primary objectives.

Constructing a simulation game 106 may include constructing a plurality of simulated scenarios that may be based in part on the organization data 104. The simulated scenarios may correlate to one or more success metrics of the organization 102. A simulated scenario may simulate an organization event (e.g., change of leadership or ownership, newly enacted regulation affecting the organization, expansion or contraction of the organization, etc.) or crisis (employee strike, leadership scandal, lawsuit, industrial accident, etc.). As an example, a simulated scenario may comprise an employee strike and the simulation game 106 may model the employee strike using organization data 104. Players acting within various organization roles 108a-n may be instructed to make decisions to resolve the simulated employee strike, and the decisions made by the players may be evaluated to determine how the decisions impact the performance of the organization 102 to handle the simulated employee strike, which may be represented via the success metrics for the organization 102.

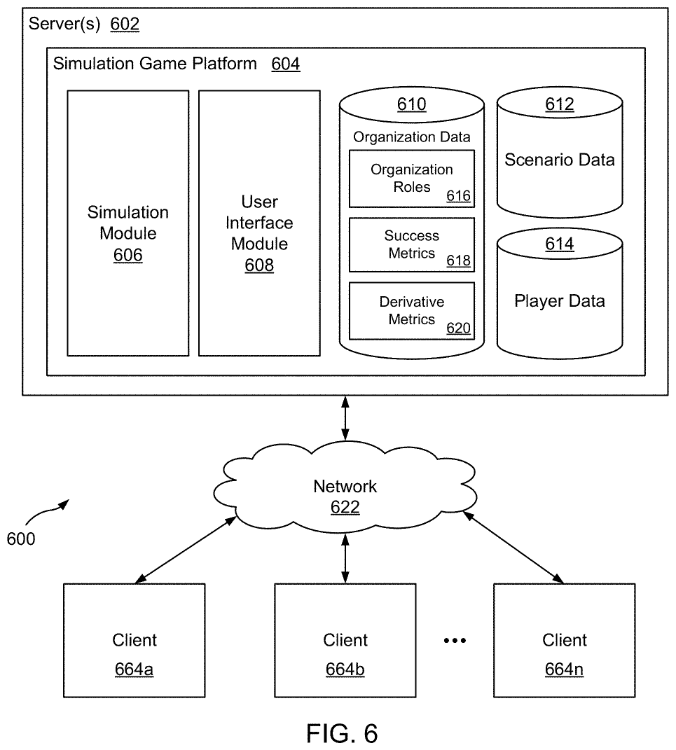

After constructing the simulation game 106 using the organization data 104, the simulation game 106 may be provided to players via a simulation game interface. The simulation game 106 may be multiplayer or single player. For example, a plurality of players may join an instance of the simulation game 106 and simultaneously work through simulated scenarios, or a player may individually work through one or more simulated scenarios, or the player may work through simulated scenarios with other simulated players (e.g., interactive agents or chatbots). In one example, the simulation game 106 may be centrally hosted on a server and players may join the simulation game 106 using client devices, as described in greater detail in FIG. 6. In another example, the simulation game 106 may be hosted on a player's device, such as a computer, workstation, mobile device, or the like.

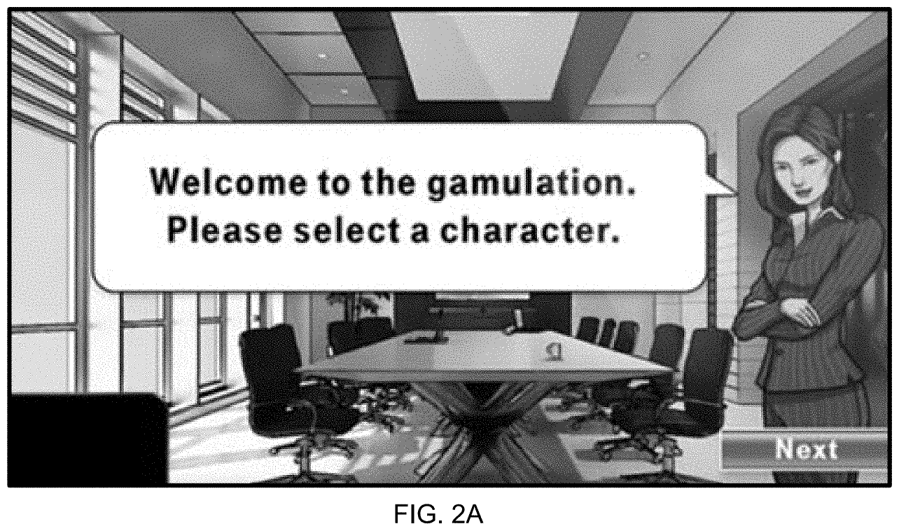

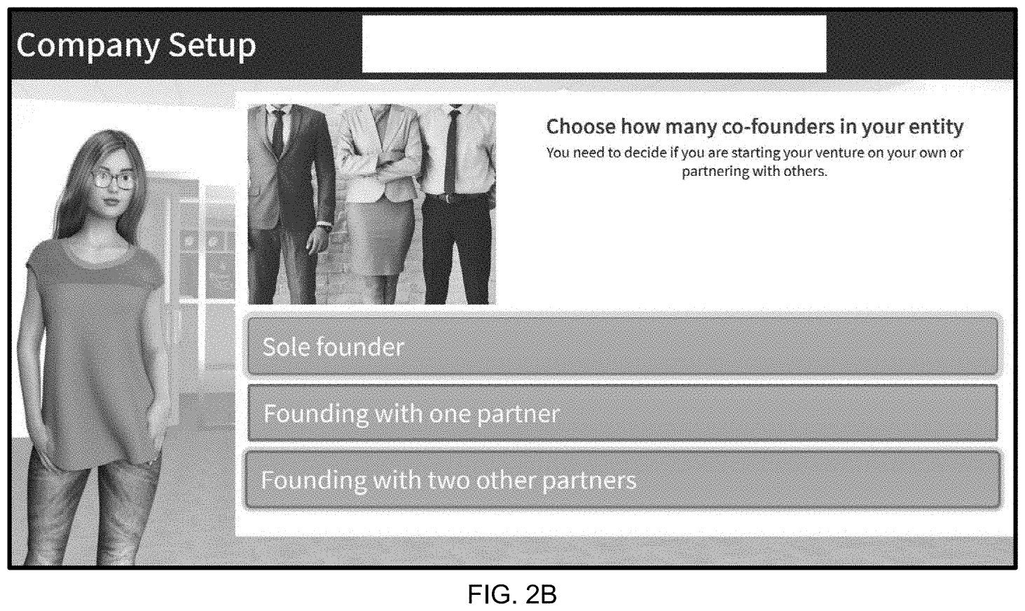

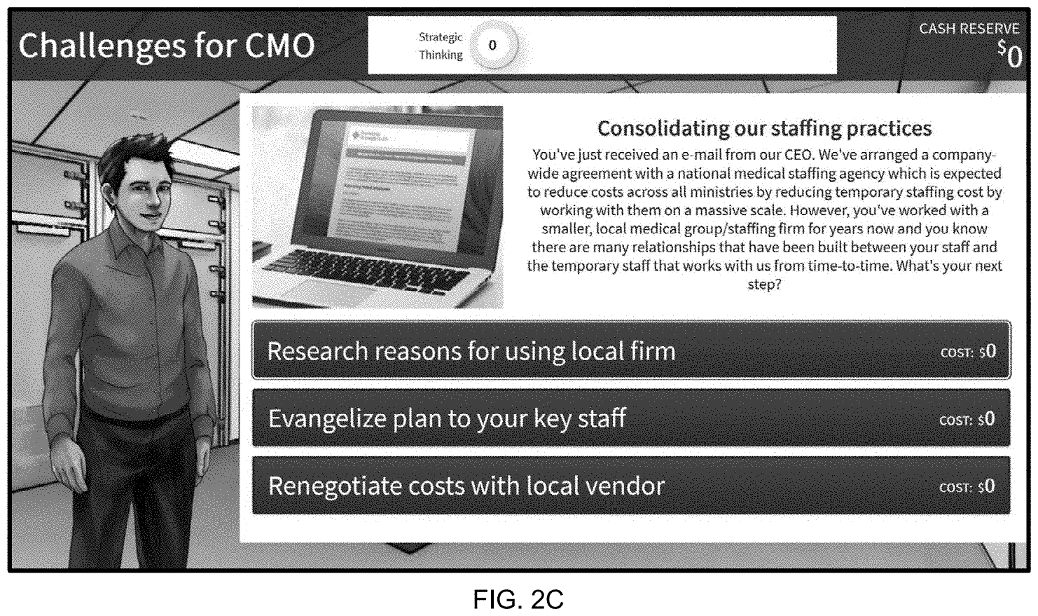

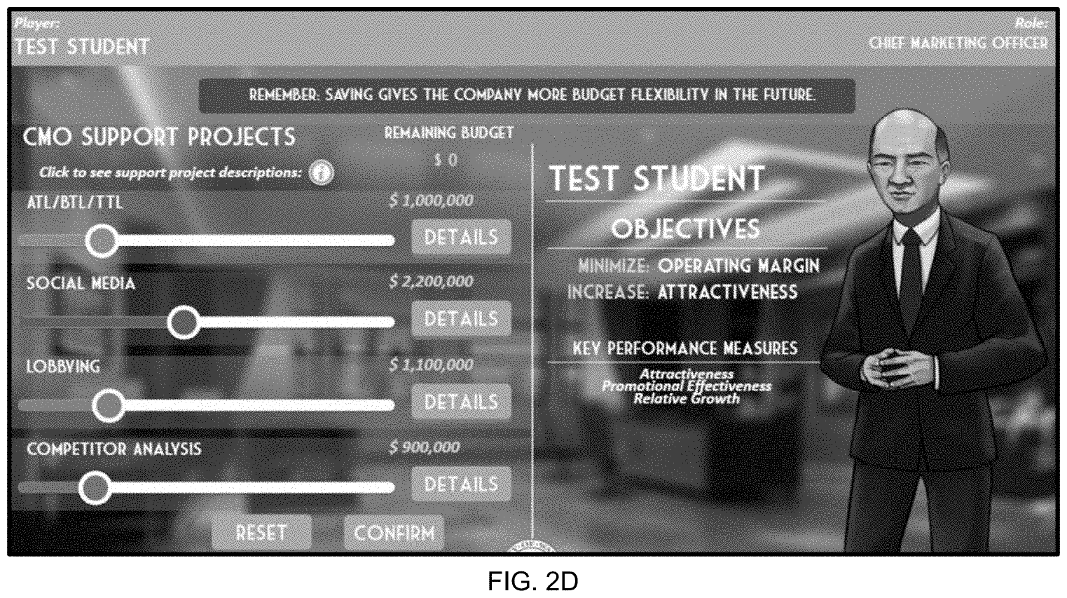

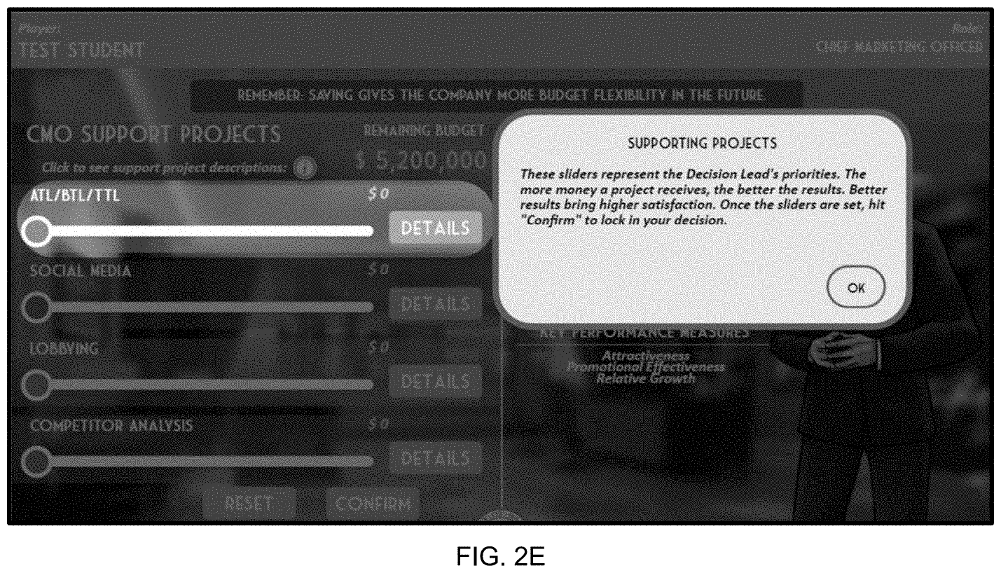

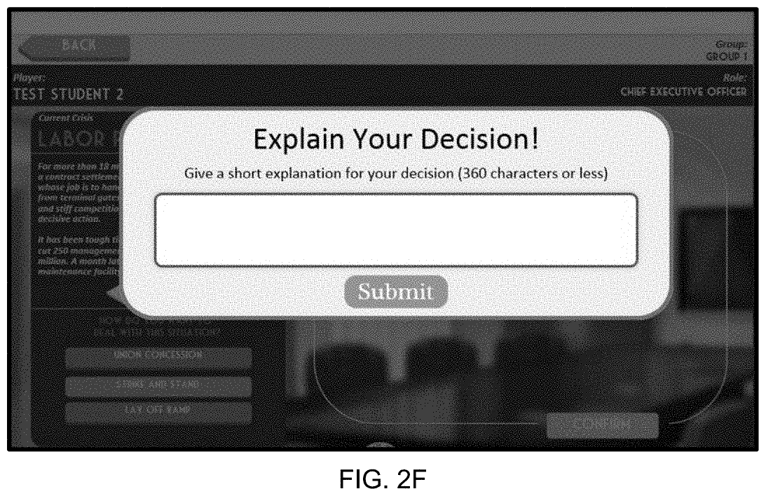

As shown in FIGS. 2A-F, a simulation game interface for the simulation game 106 may include a graphical user interface, and players may be represented in the simulation game 106 using simulated players (e.g., computer generated avatars, simulated characters, human representations, humanoids, animals, fantasy creatures, and the like). For example, FIG. 2A illustrates a welcome screen of the simulation game 106. FIG. 2B illustrates a user interface that allows a player to select parameters used to construct a simulated scenario which can then be presented to the player to work through. FIG. 2C illustrates a user interface that presents a simulated scenario to a player and presents options to the player that represent decisions the player is able to select from. FIGS. 2D-E illustrate a user interface that presents options associated with a simulated scenario using sliding controls that allow a player to make decisions by setting the sliding controls to a value. FIG. 2F illustrates a user interface that includes an input control that allows a player to explain a decision made by the player.

Returning to FIG. 1, as part of joining a simulation game 106, a player may select, or be assigned, an organization role 108a-n (e.g., CEO, COO, CFO, etc.), and the players may be provided with the organization's success metrics along with a simulated scenario that correlates to one or more of the success metrics. The player may then be instructed to make decisions regarding the simulated scenario based on the role 108a-n assigned to the player. The decisions may take numerous forms that can include multiple choice questions, budget allocations, team choice voting, open response answers, peer-to-peer feedback, and the like. In one example, a decision made by one player may define or alter a simulated scenario for another player, who may then make a decision based at least in part on the defined or altered simulated scenario. Each player can make independent decisions which can be used to calculate derivative metrics 110a-n, and the derivative metrics 110a-n may be aggregated to generate success metrics 112 for the organization 102.

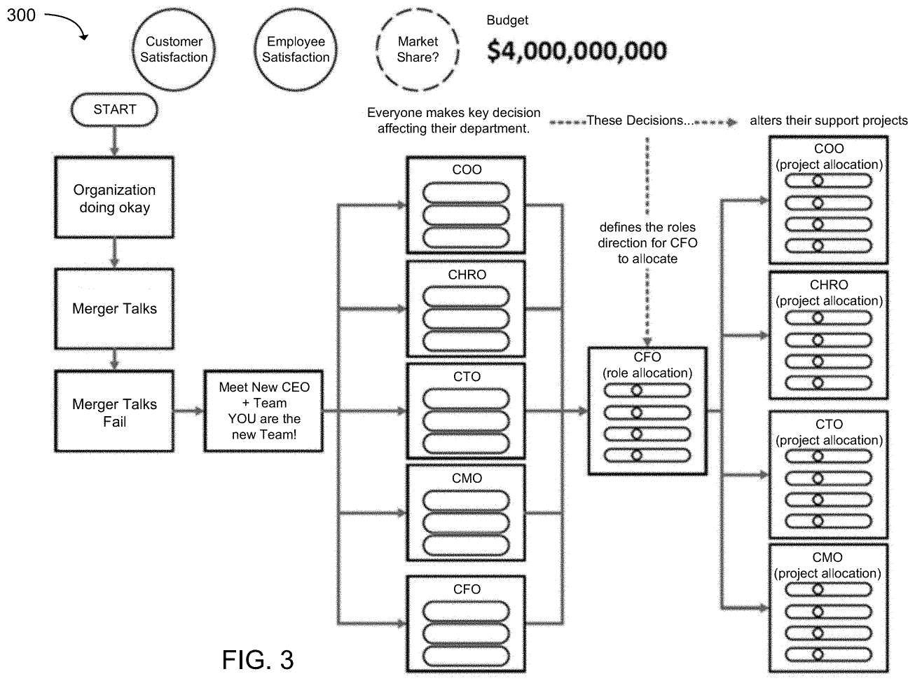

FIG. 3 illustrates one example of a simulated scenario 300 which can be provided to players within the context of a simulation game. The simulated scenario 300 can include a workflow that a player is asked to work through by assuming an organization role and make decisions related to the organization role. Decisions made by the player may determine a path of the workflow, and may affect the organization roles of other players, who can make decisions and/or perform projects based on workflow of the simulated scenario 300.

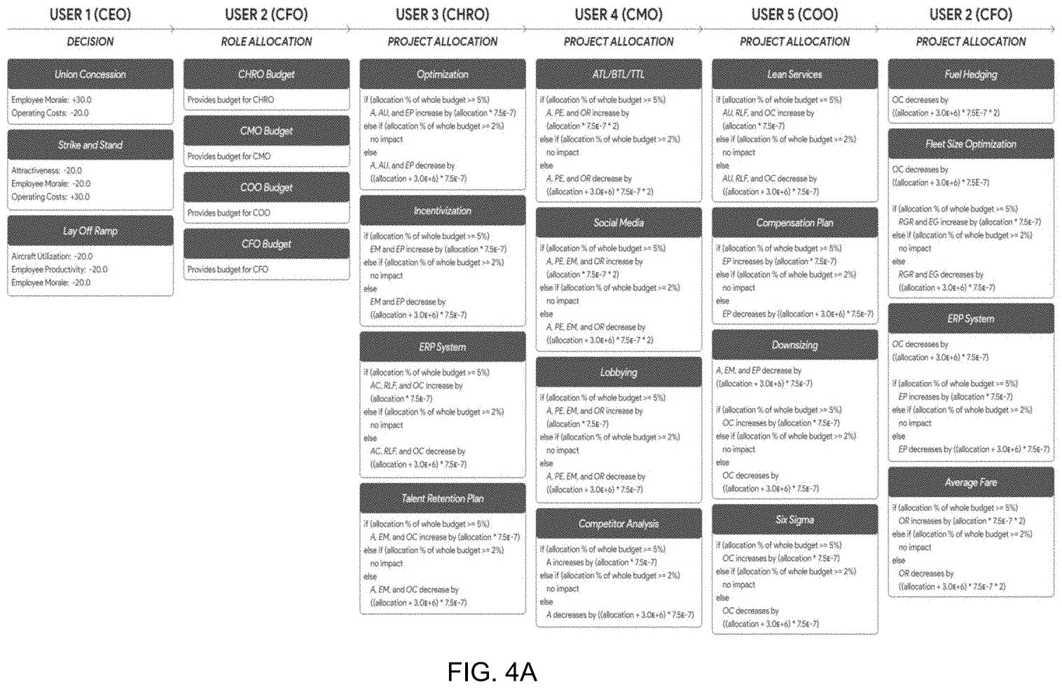

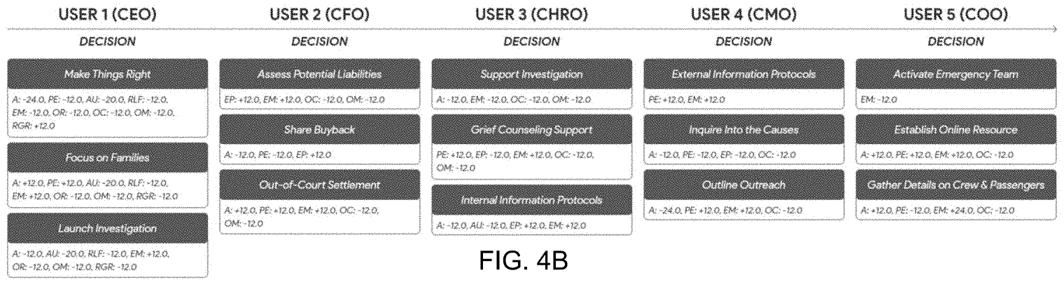

FIGS. 4A-B illustrate a non-limiting example of a simulation game constructed using example organization data for an airline entity, where success metrics for the organization can include:
Customer satisfaction
Employee satisfaction
Shareholder satisfaction
   and derivative metrics or variables that drive the success metrics can include:
Relative Growth Rate (RGR)—Available seat miles in the current period divided by available seat miles in a comparable period from the year earlier.
Relative Load Factor (RLF)—How well the average individual airplane is used. Simply stated, the load factor is that proportion of an airplane's seats that are sold and actually filled at departure.
Promotion Effectiveness (PE)—The effectiveness of the airline's promotional expenditures.
Operating Revenue (OR)—Total operating revenue per available seat mile.
Operating Margin (OM)—Total operating revenue per available seat mile less total operating cost per available seat mile.
Operating Costs (OC)—Total operating costs per available seat mile.
Equity Growth (EG)—Total equity of current period subtracted by the total equity of the earlier period.
Employee Productivity (EP)—How effectively the employees work together in providing the physical service of getting passengers from one place to another.
Employee Morale (EM)—How committed employees are to providing good service to the airline's customers.
Debt to Total Assets (DTA)—Long-term debt divided by total assets at end of period.
Attractiveness (A)—Attractiveness of the airline's service.
Aircraft Utilization (AU)—How well the companies' major assets (airplanes) are used as a group.
   As shown, the success metrics may be assigned starting values and the values may be modified based on the decisions made by the players. For example, a player may be presented with a number of options for a simulated scenario from which the player can select. The options may represent weighted decisions that the players can make, and the decisions may correlate to one or more derivative metrics that drive the success metrics. Accordingly, as the players select options representing decisions, the weights assigned to the decisions can be applied to the values of the success metrics, and the values of the success metrics can be used to represent performance of the organization as determined by the players.

As a non-limiting example that is based on the information shown in FIGS. 4A-B, the success metrics may be assigned a starting value of 20.0. The derivative metrics may be calculated by weighting the derivative metrics and summing the derivative metrics. Customer Satisfaction is the percent sum of 30% Attractiveness (A), 30% Promotion Effectiveness (PE), 20% Employee Morale (EM), and 20% Relative Growth Rate (RGR). Because the non-weighted values are 20, the weighted values are 6, 6, 4, and 4 respectively. Therefore, before making decisions, Customer Satisfaction is 20%. For the sake of concision, weighted variables are written with the prime symbol (i.e. PE′ rather than PE).

1. Player 1 (CEO) selects the lay Off Ramp′ option, which zeroes out EM. 20% of 0 is 0, so Customer Satisfaction is now 16%.

2. Player 2 (CFO) allocates 14 million to the CHRO, 11 million to the CMO, 10 million to the COO, and 11 million to their own role. In the project allocation, they put 2 million into fuel hedging, 2 million into fleet size optimization, 3 million into an ERP system, and 4 million into average fare. None of the allocations affect metrics relevant to Customer Satisfaction.

3. Player 3 (COO) allocates 1 million to lean services, 2 million to a compensation plan, 4 million to downsizing, and 3 million to six sigma. This reduces A by 3, bringing it to 17. 30% of 17 is 5.1, so Customer Satisfaction is now 15.1%.

4. Player 4 (CHRO) allocates 2 million to optimization, 4 million to incentivization, 3 million to an ERP system, and 4 million to a talent retention plan. This brings A back up to 20, making A′ equal to 6. This also increases the EM to 6. 20% of 6 is 1.20. These changes bring Customer Satisfaction to a total of 17.2%.

5. Player 5 (CMO) allocates 3 million to ATL/BTL/TTL advertising, 3 million to social media, 3 million to lobbying, and 2 million to competitor analysis. This makes A=31.3, A′=9.38; PE=31.3, PE′=9.38; and makes EM=12.8, EM′=2.55. Therefore, Customer Satisfaction becomes 25.3%.

Accordingly, Customer Satisfaction is the percent sum of the four weighted values: Attractiveness, 9.38; Promotion Effectiveness, 9.38; Employee Morale, 2.55; and Relative Growth Rate, 4.00. Therefore, Customer Satisfaction after the first round of decisions is 25.3%, wherein A′+PE′+EM′+RGR′=Customer Satisfaction which translates to 9.38+9.38+2.55+4.00=25.3%.

Returning to FIG. 1, as part of playing the simulation game 106, player behavior may be evaluated within the context of the organization 102, and specific behaviors of the players may be analyzed to provide insight into an individual's behaviors, characteristics, traits, attributes, styles, and preferences. Illustratively, player behavior that can be analyzed may include: an amount of time for a player to select a decision, the decisions a player consistently prioritizes, the degree and qualities of the decisions, the patterns of decision making or leadership style a player expresses to make decisions, a player switching a selected decision, resources used by the a player to select a decision, communications between players, communications between a player and a simulated customer, inaction of a player to select a decision, as well as other behaviors.

As an example, players can be simultaneously placed in contextual experiences to measure demonstrated behaviors of traits deemed valuable by an organization (e.g., an organization's “core competency model”). For example, players may include students and/or employees who may be placed in a simulated environment using the organization's actual data, and the player's demonstrated performance can be analyzed within the context of that actual organization. By using an organization's actual data, a cultural relevant and realistic simulation can be created that allows the organization to have higher confidence that a student or employee may have high potential talent within the organization. For example, an organization that seeks to identify employees and/or students who demonstrate attributes, such as customer focus, resiliency, strategic thinking, change agility, salesmanship, innovative thinking, loyalty, growth mindset, dependability and collaborative approach, may utilize the technology to construct a simulation game and identify players that exhibit these attributes. As a specific example, the simulation game may be configured to expose a player to customers with increasingly extreme demands, for which the player must make decisions based on finite constraints to prioritize a customer, a company, or fellow employees in order to derive a customer focus score for the player.

In one example, players may be provided with a simulated scenario and one or more of the players may be instructed to submit a written decision to the simulated scenario. The written decision may be provided to the other players who then vote on the written decision. As an example, a player may be evaluated for strategic thinking skills to understand how the player's decisions operate across an organization by exposing the player to a recent challenge facing an organization or another organization. The player may be instructed to write an open response to the challenge and the response may be evaluated by the other players in the simulation across different organization roles. The players may agree or disagree with the decision made in the response, which may be aggregated to a strategic thinking score. Also, the willingness of players to switch their decisions to align with the rest of their team may be measured, which may also be aggregated into a strategic thinking score. While each attribute and/or behavior of a player may be measured differently, the features associated with the attributes and behavior may be leveraged across many organizations who may be seeking similar attributes.

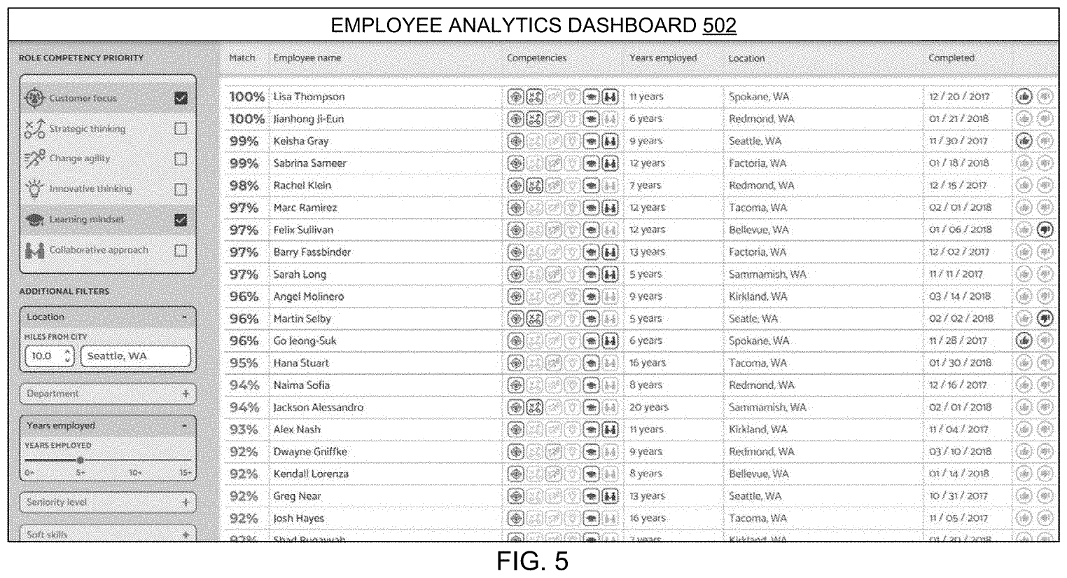

Also, in one example, a simulation game may be constructed using organization data for an actual organization and the simulation game may be provided to schools (e.g., business schools) and similar institutions where players may be exposed to the organization and allowed to make decisions related to the organization, as well as explore potential outcomes that result from the decisions. Moreover, performance data for players can be captured, and the performance data can be shared with potential employers. In one example, performance data for players can be collected and behavioral people analytics can be generated and displayed using an analytics dashboard. FIG. 5 illustrates an example analytics dashboard 502 which can be used to provide behavioral people analytics that are based on player performance data. An organization can use the behavioral people analytics displayed in the analytics dashboard 502 to determine and/or monitor a player's ability to navigate and respond to issues presented to the player in a simulated scenario. Also, the analytics dashboard 502 can be used by employers to identify high potential players who the employer may want to recruit for the employer's business.

FIG. 6 illustrates components of an example system 600 on which the present technology may be executed. The system 600 may include one or more servers 602 configured to host a simulation game platform 604. A server 602 may contain modules and data stores that comprise the simulation game platform 604. In one example, a server 602 may be located in a service provider environment (e.g., a “cloud” environment) and the server 602 may host the simulation game platform 604 within the service provider environment, such that the simulation game platform 604 may be available to clients 664a-n via a network 622.

A client 664a-n may include any device capable of sending and receiving data over a network 622. A client 664a-n may comprise, for example, a processor-based system such as a computing device. A client 664a-n may be a device such as, but not limited to, a desktop computer, laptop or notebook computer, tablet computer, handheld computer, workstation, network computer, or other devices with like capability. The server 602 may be in communication with the clients 664a-n via a network 622.

In one example, a server 602 may include a user interface module 608 and a simulation module 606. The user interface module 608 may be configured to provide simulation game output to clients 664a-n and receive simulation game input from the clients 664a-n. For example, game output may include graphics data for a simulated environment (e.g., a conference room) and game play data that may include multiple choice questions, project files, voting tools, and the like. In one example, the user interface module 608 may be used to provide a description and/or a value of one or more success metrics 618 for an organization for display to users (e.g., players, observers, administrators, etc.). For example, at the start of the simulation game, players may be provided with a description of the success metrics 618 so that the players can work towards the success metrics 618. At the end of a simulated scenario and/or at the end of game play, the value of the success metrics 618 may be provided to the players, thereby providing a measure of player performance.

The simulation module 606 may be configured to execute a simulation game using scenario data 612 and organization data 610. Illustratively, a game administrator, or a player, may initialize an instance of a simulation game and players may join the simulation game using clients 664a-n. In one example, players may be provided with a link (e.g., a hyperlink containing a uniform resource locator (URL) for the instance of the simulation game) and the players can use the link to connect to the instance of the simulation game. The simulation module 606 may be configured to assign organization roles 616 to the players, where the organization roles 616 may be mapped to derivative metrics 620. The simulation module 606 may be configured to obtain scenario data 612 from a data store and generate a simulated scenario using the scenario data 612. The simulated scenario may be based at least in part on organization data 610 and the simulated scenario may correlate to one or more success metrics 618 of an actual organization. The simulation module 606 may be configured to instruct the players, via the user interface module 608, to make decisions regarding the simulated scenario based on the organization roles 616 assigned to the players. The options provided to the players may represent decisions that can be made by the players. The options can be weighted according to an impact on the derivative metrics 620. The simulation module 606 may be configured to receive options selected by the players via the user interface module 608, and the simulation module 606 may calculate values for the derivative metrics 620 according to the weights assigned to the options. The simulation module 606 may be configured to aggregate the derivative metrics 620 to generate a value of one or more success metrics 618.

In addition, the simulation module 606 can be configured to modify the simulation game based on the value of one or more success metrics 618 and present a new simulated scenario to players based on the organization data 610 and the value of the success metrics 618. As an illustration, decisions made by the players may result in a success metric value (e.g., a poor customer service score) that may be below performance expectations. As a result, the simulation game can be modified to present a new simulated scenario that represents the poor success metric (e.g., a loss in revenue due to customer dissatisfaction).

The simulation module 606 may be configured to receive a decisions regarding a simulated scenario from a first player assigned a first role (e.g., CEO), and instruct a second player assigned a second role (e.g., CFO) to make a decision that is based at least in part on the decision selected by the first player (e.g., CFO instructed to reallocate department budget based on CEO decision to lay off employees).

The simulation module 606 can be configured to assign a project that is based on organization data 610 to a player and evaluate performance of the player to perform the project using defined standards, and the simulation module 606 can calculate a performance score that can be applied to a corresponding derivative metric 620. For example, a player can be assigned a budget project to be performed by allocating amounts using a sliding scale. The budget project can be evaluated using defined standards for how the amounts should be allocated, and a performance score can be calculated based on how well the player allocated the amounts. The performance score can then be applied to one or more corresponding derivative metrics 620.

The simulation module 606 may be configured to instruct a group of players to make a group decision regarding a simulated scenario, where the group decision can be weighted according to an impact of the group decision on a derivative metric 620, and calculate a value for the derivative metric 620 using the group decision (the weight) selected by the group of players. For example, the players can vote on a decision and a derivative metric 620 can be calculated based on the vote. In one example, a decision selected by a first player can be provided to other players and the other players can vote on the decision selected by the first player. The first player can then be instructed to select a final decision based in part on the votes of the other players. In one example, the first player may be asked to submit a written decision to the simulated scenario and the written decision can be provided to the other players who vote on the written decision.

The simulation module 606 can be configured to analyze performance of the player to select a decision regarding the simulated scenario and correlate the performance to defined attributes (e.g., decision making skills, collaboration skills, leadership skills, etc.) associated with one or more success metrics. Analyzing performance of the player further may include, but is not limited to, analyzing an amount of time for the player to select the decision, switching from one decision to another decision, analyzing resources used by the player to select the decision, analyzing communications between the player and other players, and analyzing communications between the player and a simulated customer.

In one example, the simulation module 606 can be configured to allow a non-player to join a simulation game and observe demonstrated performance of the players. In one example, the simulation module 606 can also be configured to allow a non-player to observe aggregated reporting data on one or many users at once through a live or asynchronously generated report. For example, a user may wish to observe the players or the generated demonstrated performance reports in order to evaluate the performance of the players for screening and/or hiring purposes. In one example, the user may request to join the simulation game (e.g., via the user interface module 608) and the user can be assigned a game profile that allows the user to observe the players in the simulation game. In one example, the user may be represented in the simulation game as a simulated player (e.g., computer generated avatar, simulated character, human representation, humanoid, animal, fantasy creature, and the like) which may be visible to the players, and in some examples, the user may interact with the players. In another example, the user may not be visible to the players, but may observe the players within the simulation game.

Also, in some examples, the simulation module 606 can be configured to capture player data 614 generated during game play which can be used to construct at least one simulated scenario for use in an educational environment in order to identify students that have attributes that correspond to one or more success metrics 618 for an organization. Similarly, the player data 614 may be used to construct simulated scenarios for use by other actual organizations that have attributes that correspond to the success metrics 618 of the organization.

The various processes and/or other functionality contained within the system 600 may be executed on one or more processors that are in communication with one or more memory modules. The system 600 may include a number of computing devices that are arranged, for example, in one or more server banks or computer banks or other arrangements. In one example, the computing devices may support a service provider environment using hypervisors, virtual machine monitors (VMMs), and other virtualization software.

The system 600 may include data stores for storing organization data 610, scenario data 612, player data 614, and other data. Organization data 610 may include data obtained from organization databases, organization literature, promotional documents, and other data. The organization data 610 may be analyzed to determine organization roles 616, success metrics 618, and derivative metrics 620 for the particular organization. The organization roles 616 may be actual positions held within an organization. The success metrics 618 may represent primary objectives for an organization and may be assigned a score representing performance of meeting the objectives. The derivative metrics 620 may represent aspects of an organization that drive or impact the success metrics 618 and the derivative metrics 620 may be assigned weights that are based on an impact that the derivative metrics 620 have on the success metrics 618. The term “data store” may refer to any device or combination of devices capable of storing, accessing, organizing and/or retrieving data, which may include any combination and number of data servers, relational databases, object oriented databases, cluster storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media. The data store may be representative of a plurality of data stores as can be appreciated.

The system 600 may use API calls, procedure calls, or other network commands that may be made in relation to the modules and services included in the system 600, and communications between the clients 664a-n and the simulation game platform 604. API calls may be implemented according to different technologies, including, but not limited to, Representational state transfer (REST) technology or Simple Object Access Protocol (SOAP) technology. REST is an architectural style for distributed hypermedia systems. A RESTful API (which may also be referred to as a RESTful web service) is a web service API implemented using HTTP and REST technology. SOAP is a protocol for exchanging information in the context of Web-based services.

The network 622 may include any useful computing network, including an intranet, the Internet, a local area network, a wide area network, a wireless data network, or any other such network or combination thereof. Components utilized for such a system may depend at least in part upon the type of network and/or environment selected. Communication over the network may be enabled by wired or wireless connections and combinations thereof.

While FIG. 6 illustrates an example of a system that may implement the techniques above, many other similar or different environments are possible. The example environments discussed and illustrated above are merely representative and not limiting.

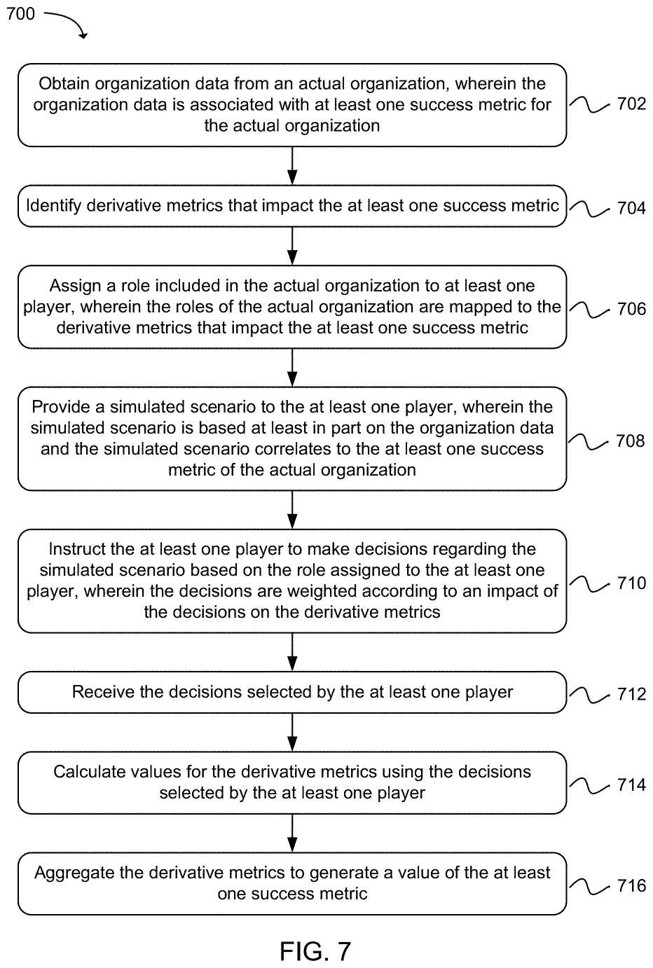

Moving now to FIG. 7, a flow diagram illustrates an example method 700 for a simulation game used to evaluate player behavior within the context of an actual organization. In the past, methods of data capture and creation were structurally limited. Generally, self-reported data was less reliable than demonstrated performance data. Further, certain human behaviors have different results in different organizational conditions. It was also economically unfeasible to scale work samples beyond key executive assessments. While traditional testing mechanisms could be used to infer behavioral tendencies, directly observing the tendency in action negates having to infer these behavioral tendencies. The present technology can be used to overcome past restraints by collecting employee work samples and other organization data from an actual organization by observing day-to-day business processes. After the organization information has been collected, a user can be placed into an organizational relevant game-based simulation that is based in part on the organization data in order to obtain behavioral people analytics for the user.

As in block 702, organization data may be obtained from an actual organization, wherein the organization data is associated with at least one success metric for the actual organization. As in block 704, derivative metrics that impact the at least one success metric may be identified. For example, the organization data can be evaluated to identify success metrics for the organization. After identifying the success metrics, the organization data can be evaluated to identify derivative metrics that drive the success metrics.

As in block 706, a role included in the actual organization may be assigned to at least one player, wherein the roles of the actual organization can be mapped to the derivative metrics that impact the at least one success metric. In one example, a player can be provided with a description of a success metric for an organization so that the player can have an idea of what the player needs to achieve.

As in block 708, a simulated scenario may be provided to the at least one player, wherein the simulated scenario is based at least in part on the organization data and the simulated scenario correlates to the at least one success metric of the actual organization. For example, a workflow of the simulated scenario can be constructed to prompt a player to make decisions that affect a success metric of the actual organization by simulating an organization event (e.g., change of leadership or ownership, newly enacted regulation affecting the organization, expansion or contraction of the organization, etc.) or crisis (employee strike, leadership scandal, lawsuit, industrial accident, etc.).

As in block, 710, the at least one player can be instructed to make decisions regarding the simulated scenario based on the role assigned to the at least one player, wherein the decisions can be weighted according to an impact of the decisions on the derivative metrics. For example, weights can be assigned to options that are presented to a player, where an option selected by the player can represent a decision made by the player.

As in block 712, the decisions selected by the at least one player may be received, and as in block 714, values or scores can be calculated for the derivative metrics using the decisions selected by the at least one player. As in block 716, the derivative metrics can be aggregated to generate a value of the at least one success metric. For example, weights assigned to options selected by players can be aggregated and applied to a success metric to either increase or decrease the success metric, and the ending value of the success metric can be used to gauge the players' ability to handle the simulated scenario.

In one example, the performance of a player to select a decision regarding a simulated scenario can be analyzed, and the performance of the player can be correlated to one or more defined attributes associated with a success metric for an organization. Illustratively, analyzing performance of the player can include analyzing: an amount of time for the at least one player to select the decision, switching a selected decision, resources used by the at least one player to select the decision, communications between the at least one player and other players, or communications between the at least one player and a simulated customer.

In one example, a decision made by a first player assigned a particular role (e.g., CEO) can be used to instruct a second player assigned a different role (e.g., CFO) to make a decision that is based, at least in part, on the decision made by the first player. For example, a decision regarding a simulated scenario can be received from the first player, and the second player can be instructed to make a decision based on the decision selected by the first player.

In one example, a project can be assigned to players that can be based, at least in part, on organization data for an organization. Performance of the players to perform the project can be evaluated and a performance score can be calculated based on the performance of the players. The performance score can then be applied to a corresponding derivative metric that drives a success metric.

In one example, a group of players can be instructed to make a group decision regarding a simulated scenario, where the group decision can be weighted according to an impact of the group decision on a derivative metric. The group decision selected by the group of players can then be used to calculate a value for the derivative metric.

In one example, a decision selected by a first player to can be provided to other players. The other players can then vote on the decision selected by the first player. For example, the first player can be instructed to submit a written decision to the simulated scenario and the written decision can be provided to the other players who vote on the written decision. Thereafter, the first player can be instructed to select a final decision based in part on the votes of the other players.

In one example, the simulation game can be modified based on the value of a success metric, and a new simulated scenario can be presented to the players based, at least in part, on organization data for an organization and the value of the success metric. The players can then make decisions based on the new simulated scenario.

In some examples, a non-player may request to join a simulation game to observe other players in the simulation game. In response to the request, the non-player may be allowed to join the simulation game, and the non-player can be assigned a game profile that allows the non-player to observe the other players. In one example, the non-player may be represented in the simulation game as, for example, a computer generated avatar and the non-player can interact with the players. In another example, the non-player may not be visible to the players, but may observe the players within the simulation game.

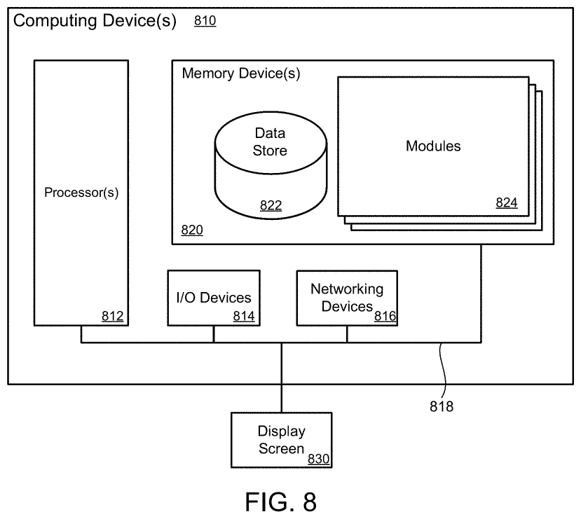

FIG. 8 illustrates a computing device 810 on which modules of this technology may execute. A computing device 810 is illustrated on which a high level example of the technology may be executed. The computing device 810 may include one or more processors 812 that are in communication with memory devices 820. The computing device 810 may include a local communication interface 818 for the components in the computing device. For example, the local communication interface 818 may be a local data bus and/or any related address or control busses as may be desired.

The memory device 820 may contain modules 824 that are executable by the processor(s) 812 and data for the modules 824. For example, the memory device 820 may include a simulation module, a user interface module, and other modules. The modules 824 may execute the functions described earlier. A data store 822 may also be located in the memory device 820 for storing data related to the modules 824 and other applications along with an operating system that is executable by the processor(s) 812.

Other applications may also be stored in the memory device 820 and may be executable by the processor(s) 812. Components or modules discussed herein can be implemented in the form of software using high-level programming languages that are compiled, interpreted, or executed using a hybrid of the methods.

The computing device may also have access to I/O (input/output) devices 814 that are usable by the computing devices. An example of an I/O device is a display screen 830 that is available to display output from the computing device 810. Networking devices 816 and similar communication devices may be included in the computing device. The networking devices 816 may be wired or wireless networking devices that connect to the internet, a LAN, WAN, or other computing network.

The components or modules that are shown as being stored in the memory device 820 may be executed by the processor(s) 812. The term “executable” may mean a program file that is in a form that may be executed by a processor 812. For example, a program in a higher level language may be compiled into machine code in a format that may be loaded into a random access portion of the memory device 820 and executed by the processor 812, or source code may be loaded by another executable program and interpreted to generate instructions in a random access portion of the memory to be executed by a processor. The executable program may be stored in any portion or component of the memory device 820. For example, the memory device 820 may be random access memory (RAM), read only memory (ROM), flash memory, a solid state drive, memory card, a hard drive, optical disk, floppy disk, magnetic tape, or any other memory components.

The processor 812 may represent multiple processors and the memory device 820 may represent multiple memory units that operate in parallel to the processing circuits. This may provide parallel processing channels for the processes and data in the system. The local interface 818 may be used as a network to facilitate communication between any of the multiple processors and multiple memories. The local interface 818 may use additional systems designed for coordinating communication such as load balancing, bulk data transfer and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, a non-transitory machine readable storage medium, such as RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media.

Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A system for a simulation game for assessing player behavior in context of an actual organization, comprising:
at least one processor;
a memory device including instructions that, when executed by the at least one processor, cause the system to:
assign roles of an actual organization to a plurality of players, wherein the roles are mapped to derivative metrics determined to impact at least one success metric of the actual organization;
present a simulated scenario to the plurality of players, wherein the simulated scenario is based at least in part on organization data and the simulated scenario correlates to the at least one success metric of the actual organization;
instruct the plurality of players to make decisions regarding the simulated scenario based on the roles assigned to the plurality of players, wherein the decisions are weighted according to an impact of the decisions on the derivative metrics;
receive the decisions selected by the plurality of players;
calculate values for the derivative metrics using the decisions selected by the plurality of player; and
aggregate the derivative metrics to generate a value of the at least one success metric.

2. The system as in claim 1, wherein the memory device includes instructions that, when executed by the at least one processor, cause the system to:
receive a decision regarding the simulated scenario from a first player assigned a first role; and
instructing a second player assigned a second role to make a decision that is based at least in part on the decision selected by the first player.

3. The system as in claim 1, wherein the memory device includes instructions that, when executed by the at least one processor, cause the system to:
modify the simulation game based on the value of the at least one success metric; and
present a new simulated scenario to the plurality of players that is based at least in part on the organization data and the value of the at least one success metric.

4. The system as in claim 1, further comprising a scenario data store for simulated scenarios that are based at least in part on the organization data and the value of the at least one success metric.

5. A computer implemented method for a simulation game, comprising:
obtaining organization data from an actual organization, wherein the organization data is associated with at least one success metric for the actual organization;
identifying derivative metrics that impact the at least one success metric;
assigning a role included in the actual organization to at least one player, wherein the roles of the actual organization are mapped to the derivative metrics that impact the at least one success metric;
providing a simulated scenario to the at least one player, wherein the simulated scenario is based at least in part on the organization data and the simulated scenario correlates to the at least one success metric of the actual organization;
instructing the at least one player to make decisions regarding the simulated scenario based on the role assigned to the at least one player, wherein the decisions are weighted according to an impact of the decisions on the derivative metrics;
receiving the decisions selected by the at least one player;
calculating values for the derivative metrics using the decisions selected by the at least one player; and
aggregating the derivative metrics to generate a value of the at least one success metric.

6. The method as in claim 5, further comprising assigning starting values to the success metrics and applying weights of the decisions selected by the at least one player to the values of the success metrics.

7. The method as in claim 5, further comprising:
assigning a project to the at least one player that is based at least in part on the organization data;
evaluating performance of the at least one player to perform the project; and
calculating a performance score that is applied to a corresponding derivative metric.

8. The method as in claim 5, further comprising:
instructing a group of players to make a group decision regarding the simulated scenario, wherein the group decision is weighted according to an impact of the group decision on a derivative metric; and
calculating a value for the derivative metric using the group decision selected by the group of players.

9. The method as in claim 5, further comprising:
analyzing behavior of the at least one player associated with selecting a decision regarding the simulated scenario; and
generating a behavioral profile for the at least one player to indicate at least one demonstrated behavioral attribute of the at least one player.

10. The method as in claim 9, wherein analyzing the behavior of the at least one player further comprises analyzing: an amount of time for the at least one player to select the decision, switching a selected decision, resources used by the at least one player to select the decision, a failure to select a decision, communications between the at least one player and other players, or communications between the at least one player and a simulated customer.

11. The method as in claim 5, further comprising:
providing a decision selected by a first player to other players;
receiving votes on the decision selected by the first player from the other players; and
instructing the first player to select a final decision based in part on the votes of the other players.

12. The method as in claim 11, further comprising instructing the first player to submit a written decision to the simulated scenario that is provided to the other players who vote on the written decision.

13. The method as in claim 5, further comprising:
capturing player data generated during game play; and
constructing at least one simulated scenario for use in an educational environment to identify students that have attributes that correspond to the at least one success metric for the actual organization.

14. The method as in claim 5, further comprising:
capturing player data generated during game play; and
constructing at least one simulated scenario for use by other actual organizations that have attributes that correspond to the at least one success metric for the actual organization.

15. A non-transitory machine readable storage medium including instructions embodied thereon for a simulation game, the instructions when executed by one or more processors:
assign roles of an actual organization to a plurality of players, wherein the roles are mapped to derivative metrics determined to impact at least one success metric of the actual organization;
retrieve a simulated scenario from a scenario data store that is based at least in part on organization data and correlates to the at least one success metric of the actual organization;
instruct the plurality of players to make decisions regarding the simulated scenario based on the roles assigned to the plurality of players, wherein the decisions are weighted according to an impact of the decisions on the derivative metrics;
receive the decisions selected by the plurality of players;
calculate values for the derivative metrics using the decisions selected by the plurality of players; and
aggregate the derivative metrics to generate a value of the at least one success metric.

16. The non-transitory machine readable storage medium in claim 15, further comprising instructions that when executed by the one or more processors cause the one or more processors to:
generate a link containing a uniform resource locator (URL) for an instance of the simulation game; and
send the link to a client device associated with a player to allow the client device to connect to the instance of the simulation game.

17. The non-transitory machine readable storage medium in claim 15, further comprising instructions that when executed by the one or more processors cause the one or more processors to generate a user interface to display the simulated scenario to the plurality of players and display a list of weighted options to the plurality of players, wherein a weighted option selected by a player represents a decision of the player with respect to the simulated scenario.

18. The non-transitory machine readable storage medium in claim 15, further comprising instructions that when executed by the one or more processors cause the one or more processors to further provide a description of the at least one success metric of the actual organization for display to the plurality of players.

19. The non-transitory machine readable storage medium in claim 15, further comprising instructions that when executed by the one or more processors cause the one or more processors to further provide the value of the at least one success metric for display to the plurality of players.

20. The non-transitory machine readable storage medium in claim 15, further comprising instructions that when executed by the one or more processors cause the one or more processors to further:
receive a request from a non-player to join the simulation game; and
join the non-player to the simulation game, wherein the non-player is assigned a game profile that allows the non-player to observe the plurality of players.
